(19) United States
(12) Patent Application Publication
(10) Pub. No.: US 2009/0102999 A1
(43) Pub. Date: Apr. 23, 2009

(54) MONITOR DEVICE WITH OPTICAL DRIVER

(75) Inventors: LI-CHUN HU, Shenzhen (CN); XIAO-LIN GAN, Shenzhen (CN); YU-KUANG HO, Taipei Hsien (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Taipei Hsien (TW)

(21) Appl. No.: 11/957,494

(22) Filed: Dec. 17, 2007

(30) Foreign Application Priority Data
Oct. 18, 2007 (CN) 200710202134.1

(51) Int. Cl. G02F 1/1333

(52) U.S. Cl. 349/58

(57) ABSTRACT

An exemplary monitor includes an LCD, a supporting frame, and a base receiving an optical driver, a power circuit, and a USB hub therein. The LCD is mounted on the supporting frame, which is mounted to the base, the power circuit is configured for providing power to the LCD and the optical driver, the optical driver is connected to the USB hub through a first USB cable, the USB hub is connected to a port of a computer through a second USB cable.

### BACKGROUND

1. Field of the Invention

The present invention relates to a monitor device, and particularly to a monitor device with an optical driver.

2. Description of Related Art

Nowadays, computers are widely used by persons for word processing, multimedia playing, and access to internet for both research and communications. Monitors are often put on the desks as output devices of the computers. But conventional monitors only function as displays.

What is needed, therefore, is a monitor device with other functions such as an optical driver.

### SUMMARY

An exemplary monitor includes an LCD, a supporting frame, and a base receiving an optical driver, a power circuit, and a USB hub therein. The LCD is mounted on the base by the supporting frame, the power circuit is configured for providing power to the LCD and the optical driver, the optical driver is connected to the a computer through a first USB cable connected to the USB hub, which is connected to a port of the computer through a second USB cable.

Other advantages and novel features will become more apparent from the following detailed description when taken in conjunction with the accompanying drawings, in which:

### BRIEF DESCRIPTION OF THE DRAWINGS

FIG. 1 is a front elevation view of a monitor according to an embodiment of the present invention;

FIG. 2 is a side elevation view of the monitor of FIG. 1; and

FIG. 3 is a circuit diagram of the monitor of FIG. 1.

### DETAILED DESCRIPTION

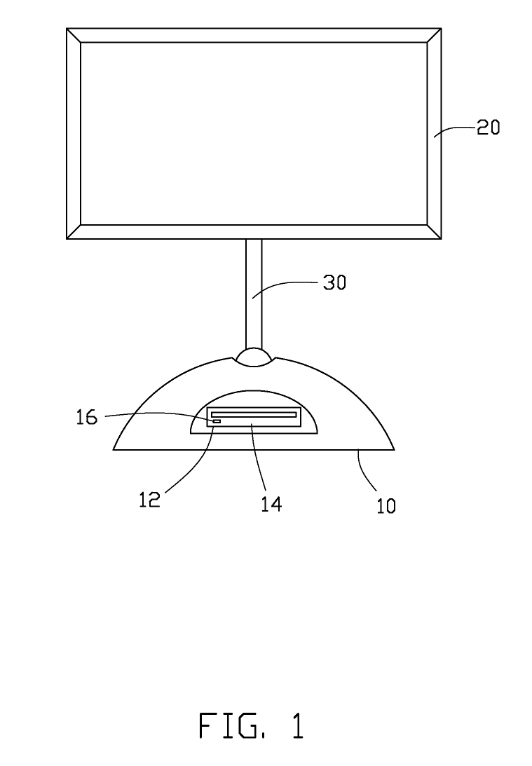

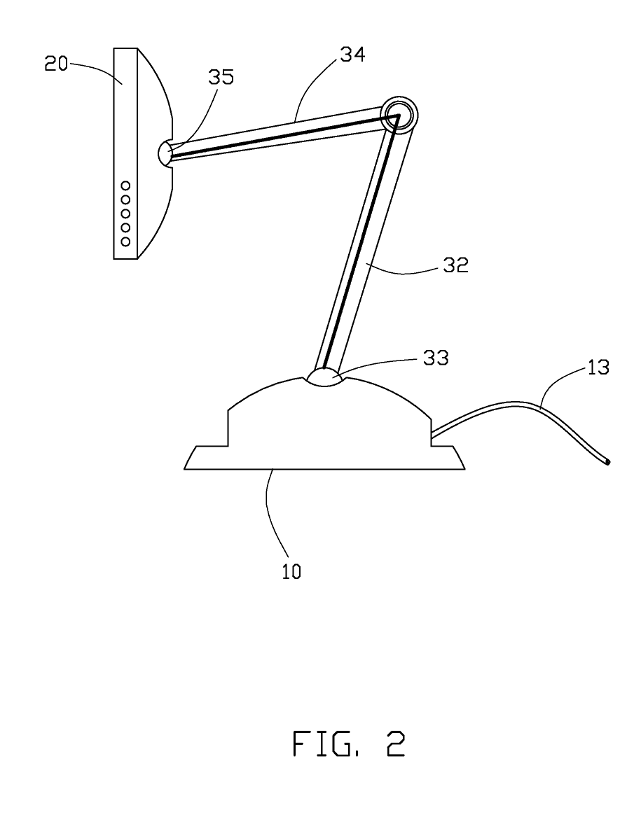

Referring to FIGS. 1 and 2, a monitor according to an embodiment of the present invention includes a base 10, a supporting frame 30, and a liquid crystal display (LCD) 20.

The base 10 has a hemispherical shape and includes an opening 12 in a front thereof. An optical driver 14 is received in the opening 12. The optical driver 14 includes a button 16 projecting from a front surface of the optical driver 14 for controlling sliding a disc or disc tray into or out from the optical driver 14. The base 10 has a spherical hole defined in a top surface thereof. A back of the LCD 20 has a spherical hole defined therein.

The supporting frame 30 includes a first post 32 and a second post 34, an end of the first post 32 includes a spherical head 33 disposed thereon, the spherical head 33 is adapted to mate with the spherical hole of the base 10, the other end of the first post 32 is pivotably connected to an end of the second post 34, the other end of the second post 34 includes a spheriacal head 35 disposed thereon, and the spherical head 35 is adapted to mate with the spherical hole of the LCD 20. The LCD 20 is mounted on the supporting frame 30, which is mounted on the base 10, and the structure of the supporting frame 30 allows users to pan and tilt the LCD 20 to obtain a best viewing angle. Each of the first post 32 and the second post 34 includes a guide conduit defined therein, signal cables and power cables connected between the LCD 20 and the base 10 can be run through the guide conduits. A rear of the base 10 has a cable 13 extended therefrom to connect to a host computer 60.

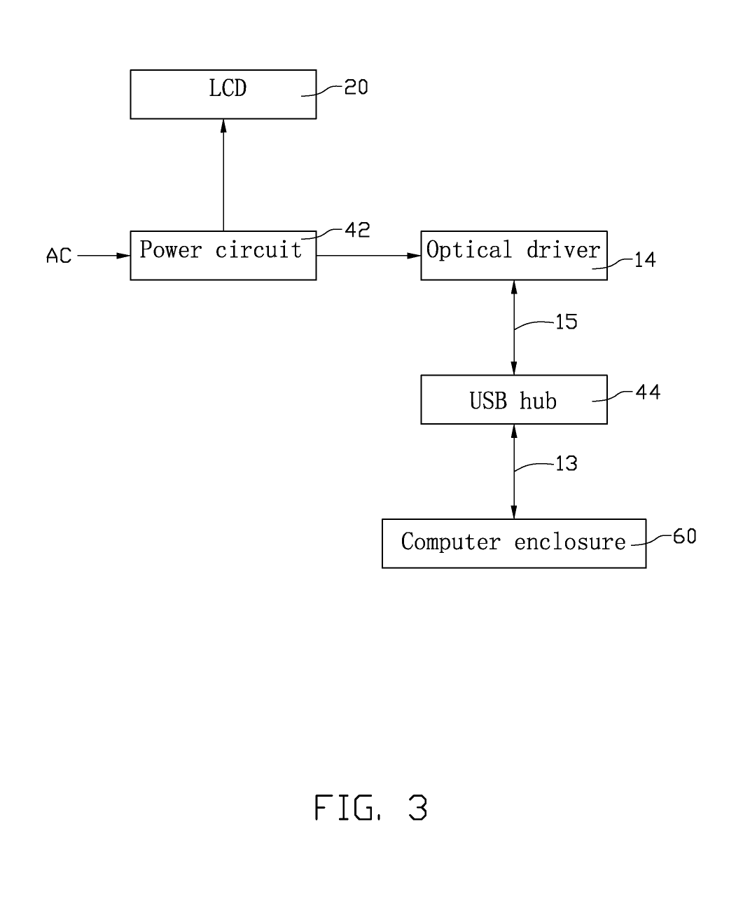

Referring to FIG. 3, the base 10 further includes a power circuit 42 and a USB hub 44, the power circuit 42 is adapted for converting AC power into 12V DC power and 5V DC power, the 12V DC power is provided to the LCD 20, and the 5V DC power is provided to the optical driver 14. The optical driver 14 is connected to the host computer 60 via a cable 15 connected to the USB hub 44, which is connected to a USB port of the host computer 60 via the cable 13. The cable 13 includes electrical wires for transmitting USB signals and video signals.

The optical driver 14 is incorporated in the monitor via the USB hub 44, because the monitor is often put on the desk, thus a user can use the LCD 20 and the optical driver 14 easily, adding greater functionality to the monitor.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A monitor, comprising:
a liquid crystal display (LCD);
a supporting frame; and
a base receiving an optical driver, a power circuit, and a USB hub therein, the LCD mounted on the base by the supporting frame, the power circuit configured for providing power to the LCD and the optical driver, the optical driver connected to a host computer through a first USB cable connected to the USB hub, which is connected to a port of the host computer through a second USB cable.

2. The monitor as claimed in claim 1, wherein when the base has a hemispherical shape and includes an opening in a front thereof, the optical driver is received in the opening.

3. The monitor as claimed in claim 1, wherein the power circuit provides a 12V DC voltage to the LCD, and a 5V voltage to the optical driver.

4. The monitor as claimed in claim 1, wherein the base has a spherical hole defined therein, the LCD has a spherical hole defined therein, the supporting frame comprises a first post and a second post, an end of the first post comprises a first spherical head disposed thereon, the first spherical head is adapted to mate with the spherical hole of the base, the other end of the first post is pivotably connected to an end of the second post, the other end of the second post comprises a second spheriacal head disposed thereon, and the second spherical head is adapted to mate with the spherical hole of the LCD.

5. The monitor as claimed in claim 4, wherein each post comprises a guide conduit therein, and signal cables and power cables connected between the LCD and the base are run the guide conduits.

6. A computer system, comprising:
a monitor comprising an LCD, a supporting frame, and a base receiving an optical driver, a power circuit, and a USB hub therein, one end of the supporting frame rotatably engaged in the base and the other end of the supporting frame rotatably engaged in the LCD, the power circuit configured for providing power to the LCD and the optical driver, the optical driver connected to a host computer through a first USB cable connected to the USB hub, which is connected to a USB port of the host computer via a second USB cable.

7. The computer system as claimed in claim 6, wherein the base has a hemispherical shape and includes an opening in a front thereof, the optical driver is received in the opening.

8. The computer system as claimed in claim 6, wherein when the power circuit provides 12V DC voltage to the LCD, and 5V DC voltage to the optical driver.

9. The computer system as claimed in claim 6, wherein the base has a spherical hole defined therein, the LCD has a spherical hole defined therein, the supporting frame comprises a first post and a second post, an end of the first post comprises a first spherical head disposed thereon, the first spherical head is adapted to mate with the spherical hole of the base, the other end of the first post is pivotably connected to an end of the second post, the other end of the second post comprises a second spheriacal head disposed thereon, and the second spherical head is adapted to mate with the spherical hole of the LCD.

10. The computer system as claimed in claim 9, wherein each post comprises a guide conduit therein, and signal cables and power cables connected between the LCD and the base are run through the guide conduits.
